(19) United States
(12) Patent Application Publication
(10) Pub. No.: US 2016/0223149 A1
(43) Pub. Date: Aug. 4, 2016

(54) ASSEMBLY FOR PORTABLE LIGHT EMITTING DIODE STRIPS WITH A DETACHABLE CONNECTION APPARATUS

(71) Applicants: Matthew Gerpheide, Poway, CA (US); Phuoc N. Nguyen, San Diego, CA (US)

(72) Inventors: Matthew Gerpheide, Poway, CA (US); Phuoc N. Nguyen, San Diego, CA (US)

(21) Appl. No.: 14/987,593

(22) Filed: Jan. 4, 2016

Related U.S. Application Data
(60) Provisional application No. 62/099,469, filed on Jan. 3, 2015.

(51) Int. Cl. F21L 4/00; F21V 23/00; F21V 31/00; F21V 21/08; F21V 21/096; F21V 33/00; H05B 33/08; H05B 37/02

(52) U.S. Cl. CPC F21L 4/00; H05B 33/0845; F21V 23/001; H05B 37/0272; H05B 33/0857; F21V 21/0832; F21V 21/0965; F21V 21/0816; F21V 23/007; F21V 33/0008; F21V 31/00; F21Y 2103/003

(57) ABSTRACT

A portable LED strip kit with detachable connection apparatus that includes a LED strip that is powered portably. A LED controller assembly controls the operation of the LED strip. A power supply unit provides electrical power to the external LED strip, wherein the power supply unit includes a battery. Also, an electrical connector provides electrical connections to the LED strip. An enclosure provides housing for the LED controller circuit, the power supply unit, and the switches, receivers, or sensors, wherein the enclosure protects components inside from external elements. A detachable connection apparatus that allows the LED strip to be attached to a variety surfaces and can be removed and reapplied to different compatible surfaces and objects.

### FIELD OF THE INVENTION

The present invention generally relates to a portable light emitting diode (LED) strips, and more particularly to a kit consisting of an assembly of electrical and detachable connection components allowing the use of LED strips in a portable manner.

### BACKGROUND OF THE INVENTION

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section. Advances in LED lighting have brought about many new possibilities in lighting. For example, the small size and low power consumption of current LED arrays has enabled many new applications for portable lighting that were not practical with incandescent light bulbs. These include LED strips that can be worn on clothing by persons or animals, can be attached to portable objects, or attached to places or objects where extension cables may be impractical or undesirable.

There are still limitations in the possible uses of portable LED strips due to a number of factors. Thus it would be desirable to increase the flexibility and versatility of LED strips so that they can be used more effectively and easily in portable applications. For example, to use LED strips portably, each of the necessary components need to be purchased separately and require the user to have an advanced knowledge in electronics to understand what is needed and how to assemble each component with the others. Additionally, there is a lack of mechanisms provided that allow for the temporary or detachable connection of LED strips. The primary options available today are generally to use a weak bonding 3M sticky glue backing or no attachment mechanism at all. Lastly in prior portable LED assemblies, the electrical controller that controls the LEDs and the battery are typically mounted in separate locations. This requires two separate units to be mounted thus adding to the bulk and complexity of the LED system. This makes the LED assembly less useful for wearable applications, where simple, small, and concealable mounting is desired. Also, in some portable LED assemblies, where the controller and battery are located in different locations, exposed wiring is needed to provide electrical connections between the two components. This increases the likelihood of damage or disconnection of the components, particularly in portable applications where there may be significant movement or exposure to the elements that can cause the external electrical connections to be damaged or disconnected.

Thus it would be desired to provide a portable LED strip with a detachable connection mechanism that overcomes the limitations described above.

### SUMMARY OF THE INVENTION

This section is intended to provide a summary of certain exemplary embodiments and is not intended to limit the scope of the embodiments that are disclosed in this application.

One aspect of the disclosed embodiments relates to an LED strip with a detachable connection mechanism that can be connected to a compatible receiving surface. An LED controller provides appearance control of the LED strip. A power supply unit provides electrical power to the LED strip and the LED controller. Also, an electrical connector provides an electrical connection to the external LED strip.

An advantage of the present invention is that it provides a partially preassembled kit of components that facilitates the use of LED strips in a portable manner. The advantage of providing a detachable connection mechanism with the LED strips is that it allows for the user to apply and remove the LED strips wherever and whenever they would like. This greatly increases the versatility in how LED strips can be used and reused for a growing variety of uses. Not all people who want to use portable LED strips want to apply the LED strips permanently to a surface.

Another advantage is that the portable LED strip kit provides all of the necessary parts and some component assembly to use LED strips in a portable manner. Prior assemblies require the individual component to be purchased separately and advanced assembly methods requiring the knowledge in electrical engineering. Most people do not have the advanced knowledge and skills to build and use an LED strip portably.

These and other advantages and features of disclosed embodiments, together with the organization and manner of operation thereof, will become apparent from the following detailed description when taken in conjunction with the accompanying drawings.

### BRIEF DESCRIPTION OF THE DRAWINGS

The disclosed embodiments are described by reference to the attached drawings.

FIG. 1 shows a block diagram of a portable LED assembly in accordance with an example embodiment.

FIG. 2 shows a top view of a portable LED strip kit with a detachable connection mechanism in accordance with an example embodiment.

FIG. 3 shows a bottom view of the portable LED strip with the detachable connection mechanism shown in FIG. 2 in accordance with an example embodiment.

FIG. 4 shows a top view of an alternative portable LED strip kit with a detachable connection mechanism in accordance with an example embodiment.

FIG. 5 shows a bottom view of the alternative portable LED strip kit with a detachable connection mechanism in FIG. 4 in accordance with an example embodiment.

FIG. 6 shows a top view of an alternative portable LED strip kit with a detachable connection mechanism in accordance with an example embodiment.

FIG. 7 shows a top view of an alternative portable LED strip kit with a detachable connection mechanism in accordance with an example embodiment.

FIG. 8 shows a bottom view of an alternative portable LED strip kit with a detachable connection mechanism in accordance with an example embodiment.

FIG. 9 shows a side view of the alternative portable LED strip kit with a detachable connection mechanism in FIG. 8 in accordance with an example embodiment.

FIG. 10 shows a top view of an alternative portable LED strip kit with a detachable connection mechanism in accordance with an example embodiment.

FIG. 11 shows a cross-section view of the alternative portable LED strip kit with a detachable connection mechanism in FIG. 10 in accordance with an example embodiment.

FIG. 12 shows a bottom view of the alternative portable LED strip kit with a detachable connection mechanism in FIG. 10 in accordance with an example embodiment.

FIG. 13 shows a top view of a connection pouch accessory that provides a detachable connection mechanism for a component of the portable LED strip kit in accordance with an example embodiment.

FIG. 14 shows a side view of FIG. 13 of a connection pouch accessory that provides a detachable connection mechanism for a component of the portable LED strip kit in accordance with an example embodiment.

FIG. 15 shows a side view of an alternative connection mechanism to that shown in FIG. 14 in accordance with an example embodiment.

FIG. 16 shows a bottom view of the connection pouch accessory that provides a detachable connection mechanism for a component of the portable LED strip kit in FIG. 15 in accordance with an example embodiment.

FIG. 17 shows another side view of the alternative connection pouch shown in FIG. 15.

### DETAILED DESCRIPTION OF THE INVENTION

In the following description, for purposes of description and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

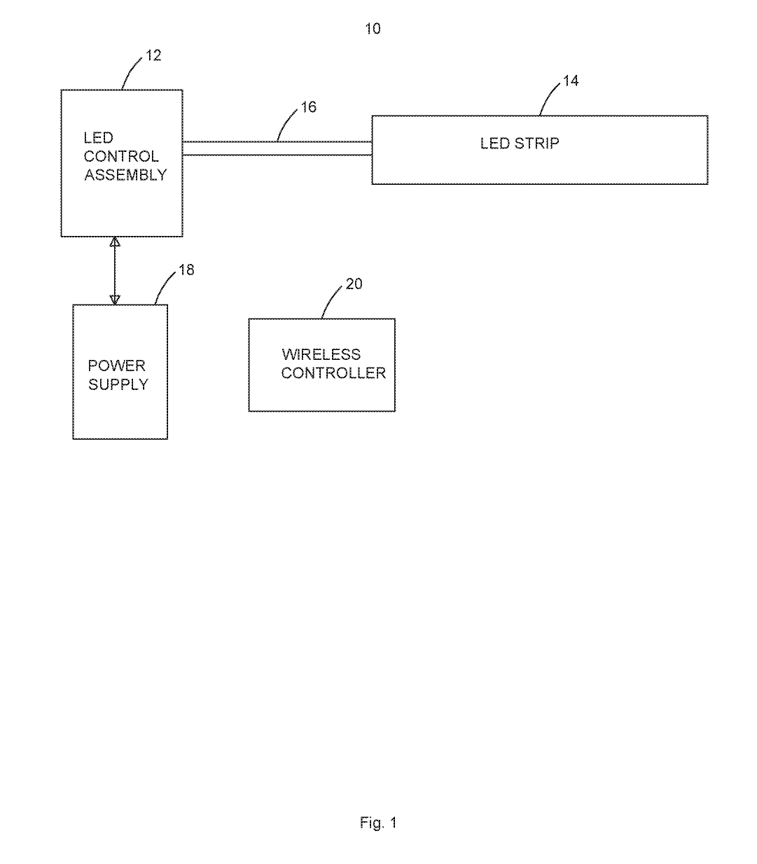

FIG. 1 shows a block diagram of a portable LED assembly 10 in accordance with an example embodiment. An LED control assembly 12 is connected to an LED strip 14. The LED control assembly 12 contains all of the electrical circuitry necessary to control to the LED strip 14, as described in more detail below. The LED strip 14 may comprise an array of LEDs, such as a strip of surface mounted LEDs. The LED strip may comprise individually addressable LEDs such as the BGreenBid WS2812b LED Pixel Strip with an IP68 waterproofing rating. Alternatively, the LED strip may also comprise addressable LEDs such as the TaoTronics® TT-SL001 12 volt LED strip with an IP65 waterproofing rating.

The portable LED assembly 10 also includes a cable 16 that provides an electrical connection between the LED control assembly 12 and the LED strip 14. The cable 16 carries the appropriate number of wires to provide electrical power and control signals to the LED strip 14. The LED assembly 10 also provides a power supply unit 18, which is used to directly provide power to the LED control assembly 12. The portable LED assembly may also include a wireless controller 20, which may allow a user to wirelessly control the operation of the LED strip 14 in some embodiments.

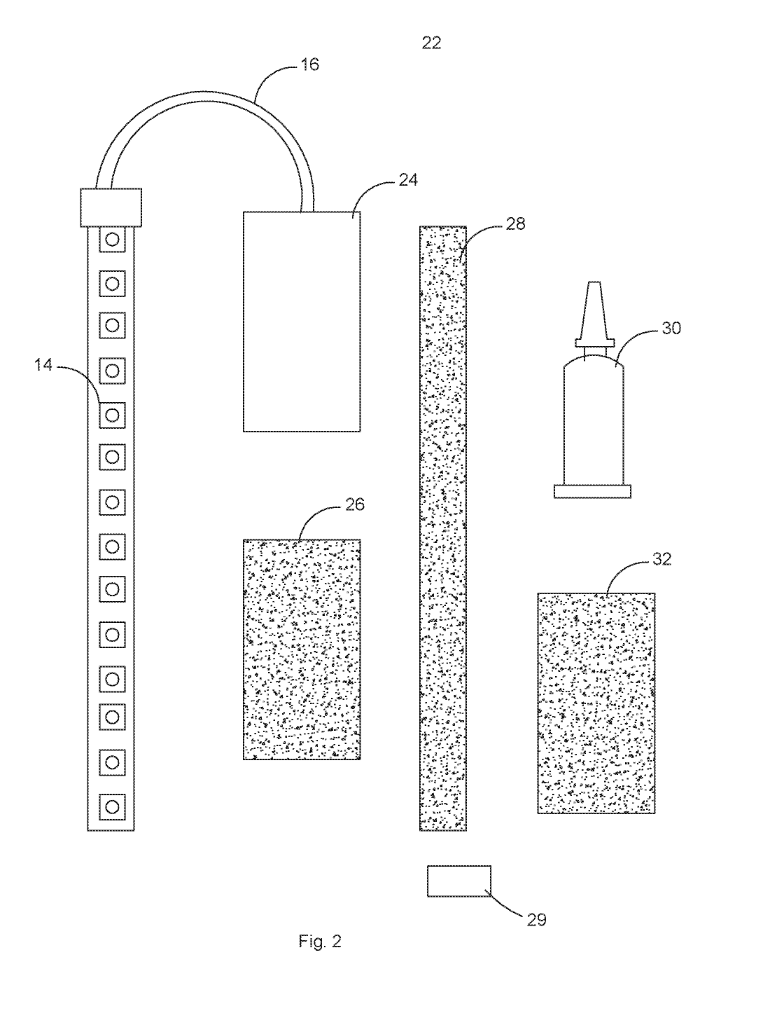

FIG. 2 shows a top view of the portable LED strip kit with detachable connection apparatus 22 in accordance with an example embodiment. An LED strip 14 is connected to a cable 16 which is connected to an enclosure 24 containing the power supply 18 and LED control assembly 12. The portable LED strip kit with detachable connection apparatus 22 also includes a patch of loop Velcro 26, a strip of loop Velcro 28, a tube of industrial adhesive 30, and a patch of hook Velcro 32.

Further details regarding the LED control assembly 12 and its functions in accordance with various embodiments are described in the attached Appendix.

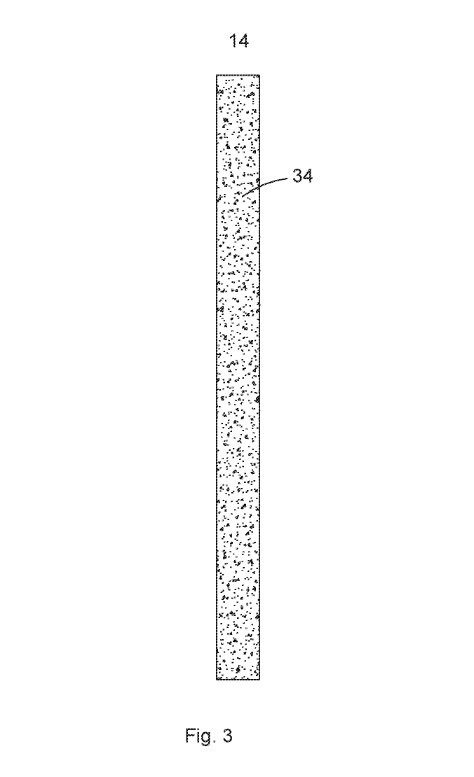

FIG. 3 shows a bottom view of the LED strip 14 shown in FIG. 2 in accordance with an example embodiment. Attached to the bottom of the LED strip 14 is a strip of hook Velcro 34.

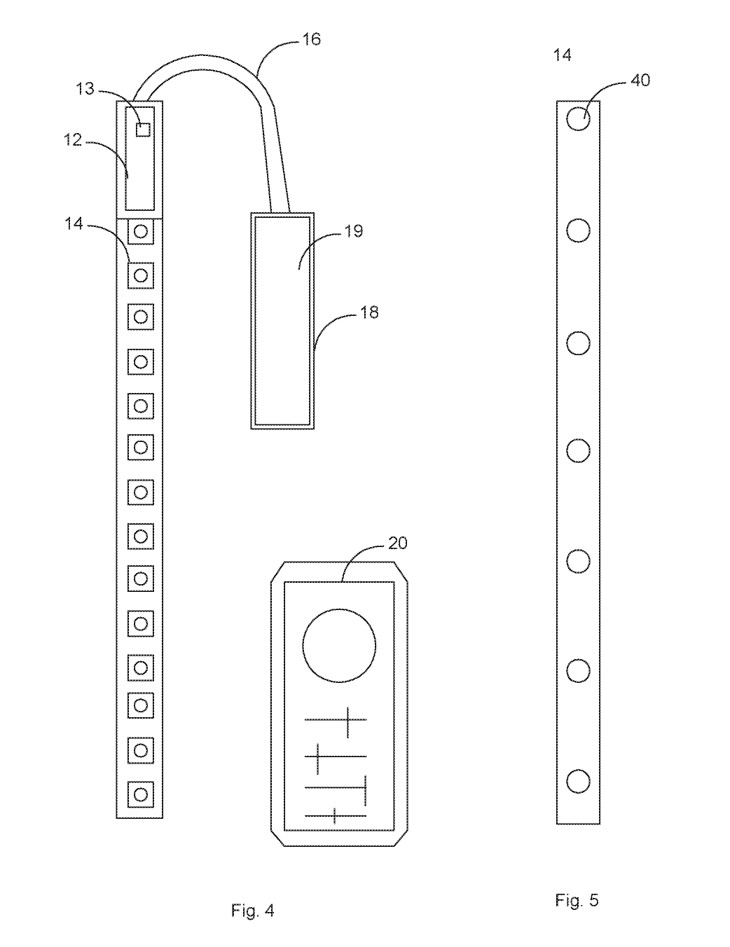

FIG. 4 shows a top view of the portable LED strip kit with detachable connection apparatus 22 in accordance with an example embodiment. An LED strip 14 includes an integrated LED control assembly 12 with a wireless receiver 13 on the end. The integrated LED control assembly 12 is connected to a cable 16 which is connected to the power supply 18. The power supply 18 has a magnet 19 attached to it. The integrated LED control assembly 12 is controlled by a wireless controller 20.

The LED control assembly 12 is mounted to the end of the LED strip 14, which is controlled via wireless signal by a wireless device 20. A wireless receiver 13 is mounted on the LED control assembly 12, which is used to receive a signal from a wireless receiver 20, and control the color, brightness, and pattern of the LED strip 14.

FIG. 5 shows a bottom view of the LED strip 14 shown in FIG. 4 in accordance with an example embodiment. Attached to the bottom of the LED strip 14 are magnets 40, which permit the portable LED strip kit with detachable connection apparatus 22 to be removably attached to any metal objects. In one embodiment, the portable LED strip kit with detachable connection apparatus 22 is attached to metal portions of a bicycle or other vehicle.

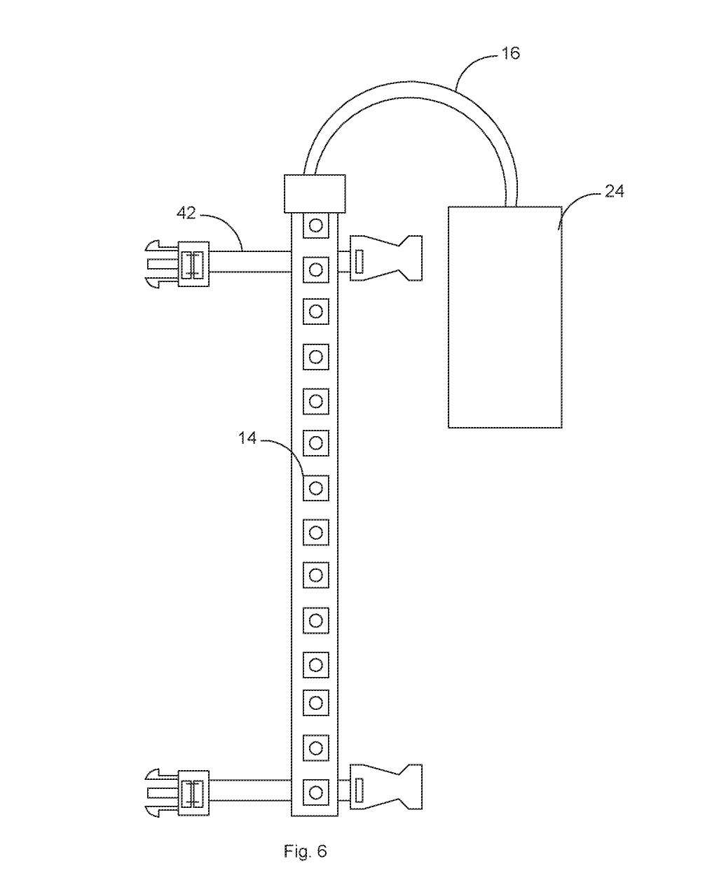

FIG. 6 shows a top view of the portable LED strip kit with detachable connection apparatus 22 in accordance with an example embodiment. Strap and buckle clips 42 are attached to an LED strip 14. The LED strip 14 is connected to a cable 16 which is connected to the enclosure 24. The strap and buckle clips 42 enable the portable LED strip kit with detachable connection apparatus 22 to be attached to a variety of objects, such as the arm or leg of a person.

FIG. 7 shows a top view of the portable LED strip kit with detachable connection apparatus 22 in accordance with an example embodiment. A strap with a male buckle clip 41 and a strap with a female buckle clip 43 are attached to each end of an LED strip 14. The LED strip 14 is connected to a cable 16 which is connected to the enclosure 24. The strap with male and female buckle clips 41 and 43 permits the portable LED strip kit with detachable connection apparatus 22 to be removably attached to objects such as the arm or leg of a user.

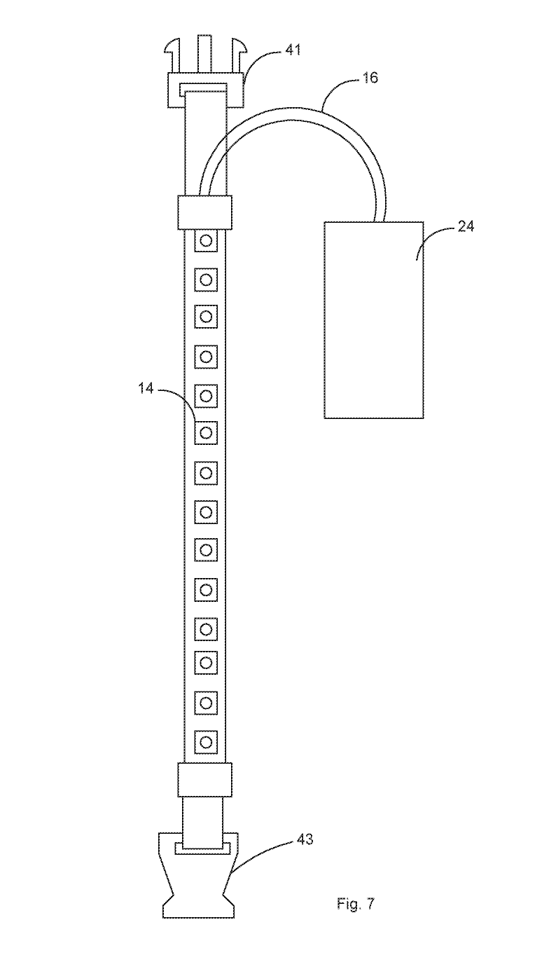

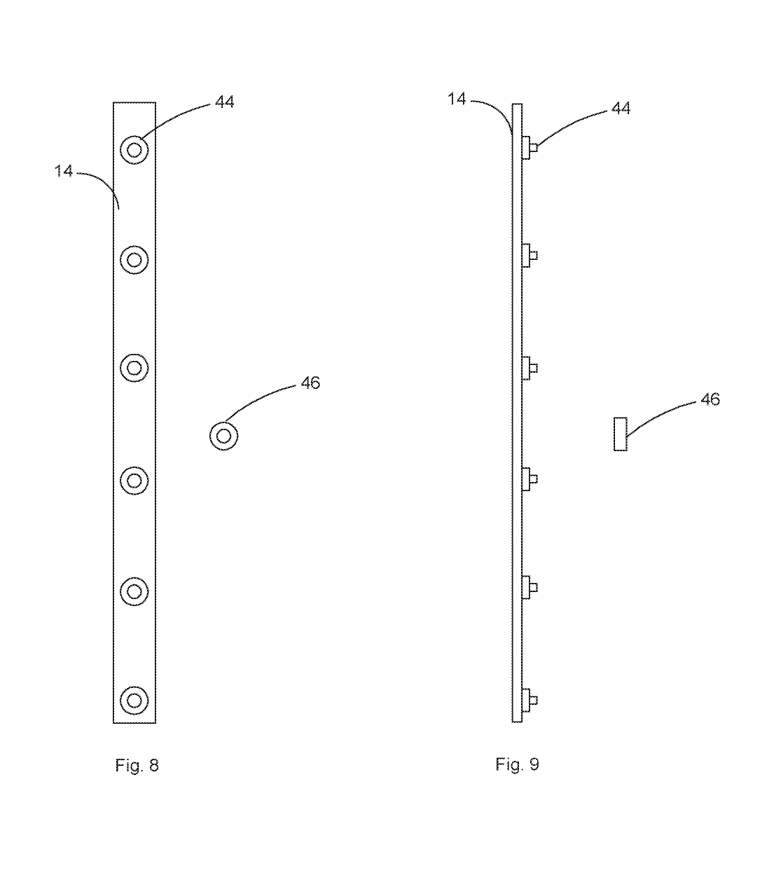

FIG. 8 shows a bottom view of the LED strip 14 with male snap buttons 44 attached to the bottom. Female snap buttons 46 will be attached to receiving surface, such as clothing or a backpack, to act as a compatible and detachable connection mechanism.

FIG. 9 shows a side view of the LED strip 14 shown in FIG. 8

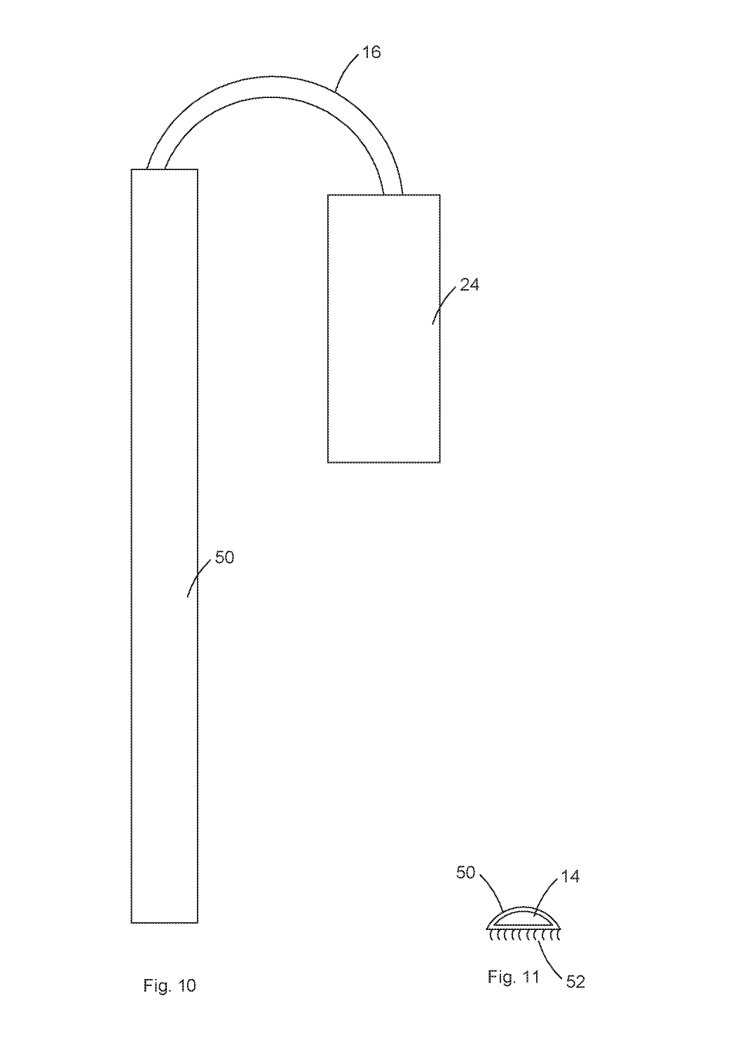

FIG. 10 shows a top view of a protective sleeve 50 covering the LED strip 14, which is connected to a cable 16 that is connected to an enclosure 24. The protective sleeve 50 would be transparent enough in at least one area, so that the light from the LED strip 14 would be visible. Additional surrounding areas of the protective sleeve 50 may not need to be transparent, since only certain areas of the LED strip 14 will be able to illuminate. The protective sleeve 50 would provide durability and protection to the LED strip 14. Additionally, the protective strip 50 may optionally provide the benefit of dispersing the light from the LED strip 14 to provide an alternative esthetic appearance. The protective sleeve may be removable or may be installed to remain geminately over the LED strip 14. The protective strip 50 may comprise a variety of materials including, canvas, cloth, rubber, silicon, plastic, or materials of the like.

FIG. 11 shows a cross-section view of the protective sleeve 50 and the LED strip 14 shown in FIG. 10. Hook style Velcro 52 is connected on the bottom side of the protective sleeve 50 to provide a means of detachable connection.

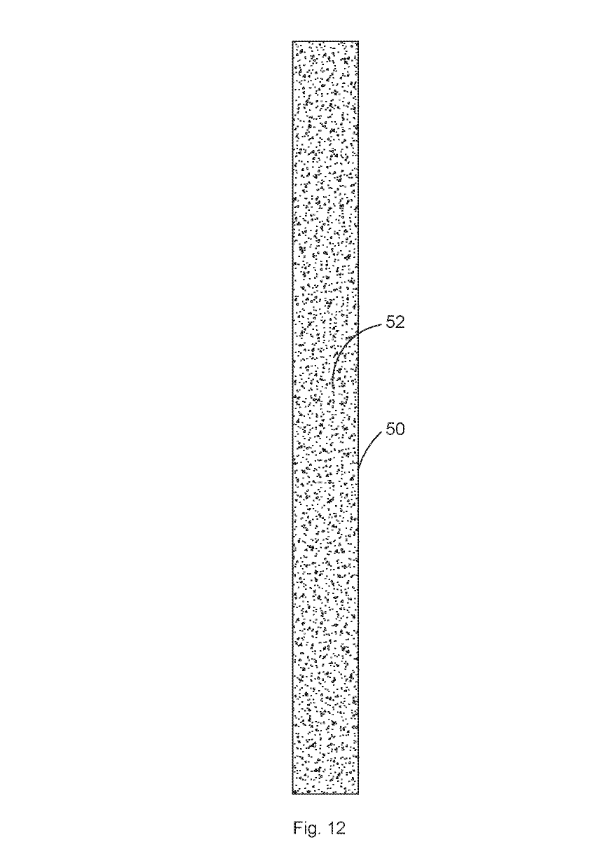

FIG. 12 shows a bottom view of the protective sleeve 50 shown in FIG. 10. Hook style Velcro 52 is connected on the bottom side of the protective sleeve 50 to provide a means of detachable connection.

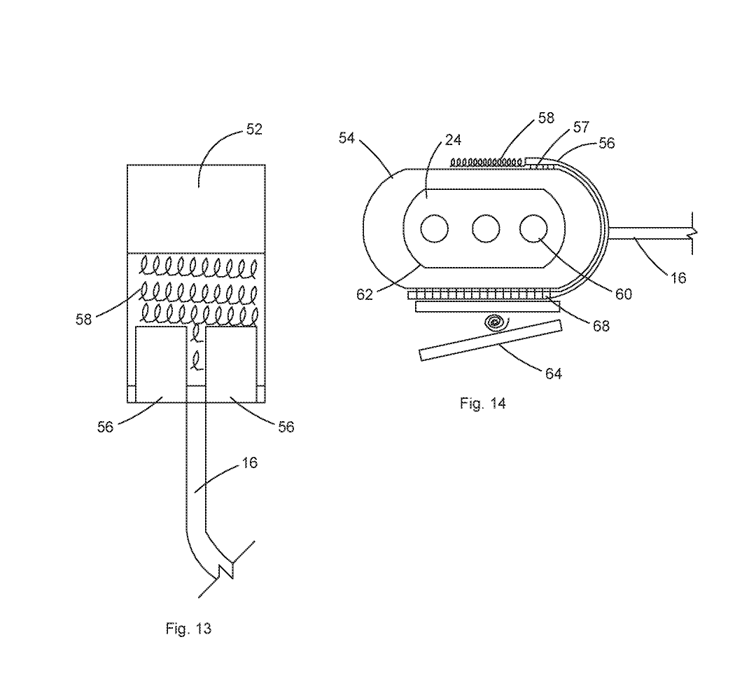

FIG. 13 shows a top view of a connection pouch 54. The connection pouch 54 has loop style Velcro 58 on top, and two flaps 56 with hook style Velcro 57 underneath. Inside the connection pouch 54 contains the enclosure 24, which is connected to a cable 16. The connection pouch 54 allows the enclosure 24 to be mounted a variety of different ways, while not being limited to one permanent mounting method. The connection pouch 54 may comprise a variety of materials including, canvas, cloth, rubber, silicon, plastic, metal, or materials of the like.

FIG. 14 shows a side view of the connection pouch 54 from FIG. 13. The connection pouch 54 is containing the enclosure 24 inside. An access cutout 62 also user access to the button controls 60 mounted on the exterior of the enclosure 24. The connection pouch 54 has loop style Velcro 58 on top, and two flaps 56 with hook style Velcro 57 underneath. A connector clip 64 is mounted on the bottom of the connection pouch 54, to allow the connection pouch and its contents to be easily clip connected to an appropriate surface or object.

FIG. 14 shows a side view of the connection pouch 54 from FIG. 13. The connection pouch 54 is containing the enclosure 24 inside. An access cutout 62 also user access to the button controls 60 mounted on the exterior of the enclosure 24. The connection pouch 54 has loop style Velcro 58 on top, and two flaps 56 with hook style Velcro 57 underneath. These flaps 56 are sewn to the connection pouch 54 by thread 68. A connector clip 64 is mounted on the bottom of the connection pouch 54, to allow the connection pouch and its contents to be easily clip connected to an appropriate surface or object, such as a user's belt or pocket.

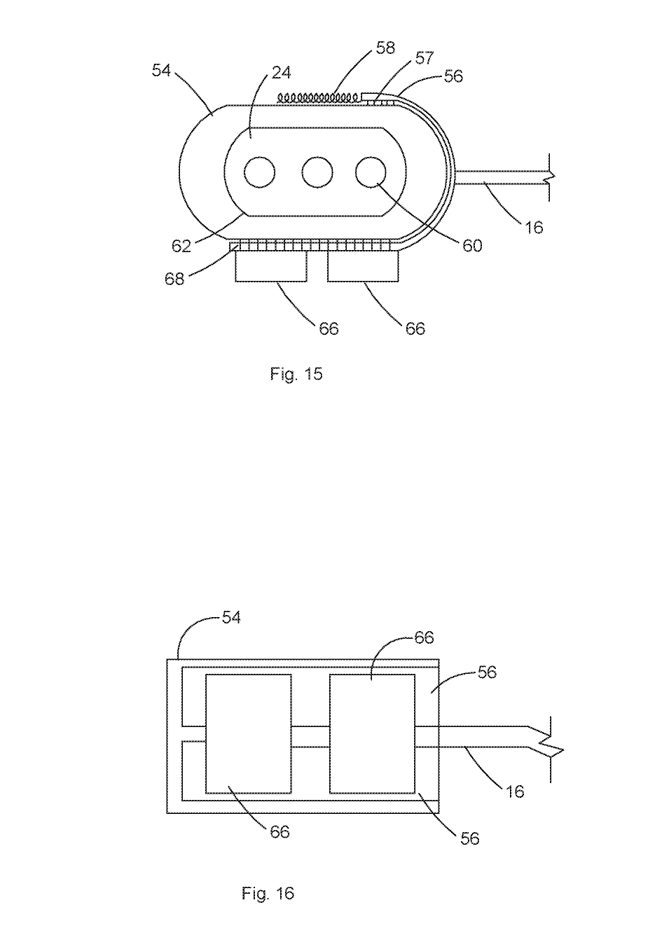

FIG. 15 shows a side view of an alternative connection pouch 54 to that shown in FIG. 14. Instead of the connector clip 64, A hoop 66 is attached to the connection pouch 54 to allow the user to attach the connector pouch 54 and its contents to objects such as a belt or other clip and strap like objects. The hoops 66 can be made of a variety of fabrics, plastics, or metals, which may give the hoops a flexible and elastic shape or a stiff rigid one. An object such as a belt can be passed through the hoops 66, which will allow the connection pouch 54 to be securely fastened to the belt. Additionally, the hoops 66 allow the user to quickly mount the connection pouch 54 to things such as dog collars, rods, canes, suspenders, or other straps and objects that can be slipped through the hoops 66.

FIG. 16 shows a bottom view of the alternative connection pouch 54 shown in FIG. 15.

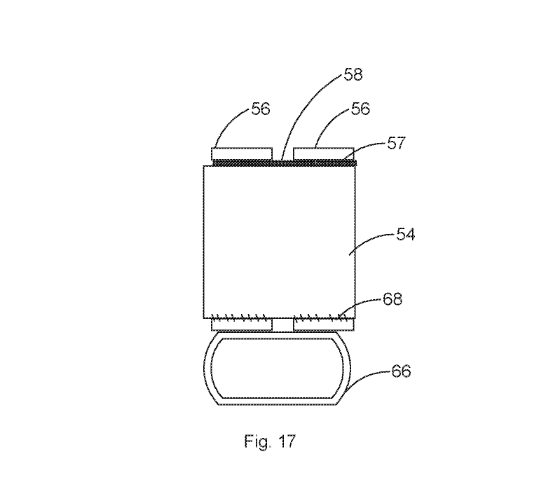

FIG. 17 shows a different side view of the alternative connection pouch 54 shown in FIG. 15.

The foregoing description of embodiments has been presented for purposes of illustration and description. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. a portable LED strip kit with detachable connection apparatus comprising:
an LED strip;
a detachable connection apparatus for connection of LED strip to a desired surface;
an LED control assembly for controlling the operation of external LEDs;
a power supply unit for providing electrical power to the external LEDs, wherein the power supply unit includes a battery;
an electrical connector for providing electrical connections to the external LEDs;

2. The LED control assembly of claim 1 wherein the one or more control devices comprise at least one of: a switch, a receiver, and a sensor.

3. The LED control assembly of claim 1 further comprising an electrical cable having a first terminal at a first end adapted to plug into the electrical connection and a second terminal at a second end adapted to connect into the LED strip.

4. The LED control assembly of claim 3 wherein the electrical cable includes at least 2 to 8 wires.

5. The LED control assembly of claim 1 wherein the one or more control devices includes command capabilities comprising at least one of: on/off, color control, brightness, and light color pattern.

6. The LED strip of claim 1 further comprising a wireless receiver imbedded in the LED strip to receive wireless signals from the operation of a wireless controller.

7. The LED control assembly of claim 6 wherein the wireless receiver receives Bluetooth signals.

8. The LED control assembly of claim 6 wherein the wireless receiver receives signals from a cell phone to control the operation of the LED controller circuit.

11. The attachment apparatus of claim 1 further comprising Velcro and industrial adhesive to provide a means of detachable connection for the LED strip.

12. The attachment apparatus of claim 1 further comprising magnets to provide a means of detachable connection for the LED strip.

13. The attachment apparatus of claim 1 further comprising straps and clips to provide a means of detachable connection for the LED strip.

14. The attachment apparatus of claim 1 further comprising snap buttons to provide a means of detachable connection for the LED strip.

15. The attachment apparatus of claim 1 further comprising zippers to provide a means of detachable connection for the LED strip.

16. The portable LED kit with detachable connection apparatus of claim 1, wherein the portable LED kit with detachable connection apparatus is designed to resist aquatic or high moisture conditions.

17. The LED strip of claim 1 further comprising of an embedded LED control assembly on the end of the LED strip.

18. The LED strip of claim 1 further comprising a protective sleeve around at least a portion of the LED strip, wherein the protective sleeve allows some of the light from the LED strip to pass through it.

19. The LED strip of claim 1 wherein the power supply unit and LED control assembly are contained in an enclosure.

20. The LED strip of claim 1 further comprising a pouch containing the enclosure.

21. The LED strip of claim 20 wherein the enclosure has a connector clip attached on one side.

22. The LED strip of claim 20 wherein the enclosure has a hoop attached to one side, whereby the pouch may be connected to an object that is passed through the hoop.

23. The LED strip of claim 22 wherein the object that is passed through the hoop is a belt.
